(19) United States
(12) Patent Application Publication
(10) Pub. No.: US 2026/0056223 A1
(43) Pub. Date: Feb. 26, 2026

(54) CUVETTE FOR ANALYZING A FLUID

(71) Applicant: HOMBRECHTIKON SYSTEMS ENGINEERING AG, Hombrechtikon (CH)

(72) Inventors: Konstantin LUTZE, Uerikon (CH); Harald QUINTEL, Steckborn (CH)

(21) Appl. No.: 19/287,524

(22) Filed: Jul. 31, 2025

(30) Foreign Application Priority Data
Aug. 22, 2024 (EP) 24196029.3

(51) Int. Cl. G01N 35/10; G01N 21/03; G01N 35/04

(52) U.S. Cl. CPC G01N 35/1011; G01N 21/0303; G01N 2021/0382; G01N 2021/0389; G01N 2035/0405

(57) ABSTRACT

A cuvette for analyzing a fluid includes an interior space for receiving the fluid. The interior space includes an analysis section for analyzing the fluid. The analysis section extends over two opposite sides of the cuvette. The cuvette also includes a first opening for filling the cuvette, the fluid can be introduced into the interior space via the first opening, and the analysis section has a first analysis path for analyzing the fluid and a second analysis path for analyzing the fluid. The first analysis path is shorter than the second analysis path such that differently concentrated fluids can be analyzed by the first analysis path and the second analysis path. The first analysis path and the second analysis path extend from a first side of the opposite sides of the cuvette to a second side of the opposite sides of the cuvette.

### CROSS-REFERENCE TO RELATED APPLICATION

This application claims priority to European Application No. 24196029.3, filed Aug. 22, 2024, the contents of which are hereby incorporated herein by reference.

### TECHNICAL FIELD

The disclosure relates to a cuvette for analyzing fluids, a method for analyzing fluids and a pipetting device with a cuvette for analyzing fluids and an automatic pipetting machine.

### BACKGROUND

In the state of the art, cuvettes are usually used to analyze small quantities of samples.

Cuvettes form a container with plane-parallel walls, in which a reaction and/or a result of a reaction is monitored or measured photometrically.

Conventional cuvettes can have a square cross-section with outer dimensions of 12.5×12.5 mm. Absorption photometers have a shaft with a corresponding cross-section, into which the cuvettes can be inserted. The beam path of the illumination device runs transversely through this cuvette shaft.

The measure of the attenuation of the beam path during passage through the sample, for example mixed with dyes (the attenuation by the glass of the cuvette itself is taken into account as a constant) designates the light absorption of the sample, so that a statement can be made about it.

Since the processed samples usually only cover a small volume, pipettes are used in the state of the art for dosing samples/liquids. Usually, pipettes are used in the medical field, wherein pipette tips are used as disposable articles made of plastic, in order to avoid contamination. For small volumes, so-called micropipettes are used, wherein small volumes of approximately 100 nanoliters and more can be pipetted. For repetitive work, there are electronically controlled pipettes, which are also used in particular in laboratory machines and robots.

Some pipettes work according to the displacement principle, wherein a movable piston displaces or draws air, whereby a liquid passes out of or into the pipette tip.

Alternatively to the displacement principle, there are pipettes in the state of the art, which work according to the air cushion principle. A corresponding pipetting device is known, for example, from DE10237770A1. Here, an air column separates the liquid sucked up in the pipette tip and an interior space of the pipette. Due to the movement of a pump element of the pump, a negative pressure arises in the pipette tip, which causes the liquid to rise into the tip. The air column moved by the pump element ensures a fluid flow, due to which the movement of the liquid into or out of the pipette tip takes place.

Furthermore, devices are known in the state of the art, which are used exclusively for dispensing liquids. In contrast to pipettes, these devices usually have a reservoir, from which the liquid is dispensed. Here, a specific volume is dispensed repetitively from the reservoir. A corresponding liquid dispensing device is known from U.S. Pat. No. 7,303,728 B2. Moreover, a liquid dispensing system for dispensing liquid volumes in the sub-microliter range is known from WO 2006005923 A1.

The liquid received in the pipette is then dispensed into a vessel, in order to analyze it there, for example into a cuvette.

The cuvettes from the state of the art here have a window, through which the liquid or sample in the interior space of the cuvette can be analyzed.

Cuvettes are also known from the state of the art, which have analysis paths of different lengths for analyzing samples. This has the advantage that samples of different density or concentration can be analyzed in a cuvette, depending on which analysis path is used. A corresponding cuvette is shown in DE 198 26 470 C2.

### SUMMARY

The disadvantage of the cuvettes described in the state of the art with different analysis paths is that the analysis paths cross in the cuvette. A simultaneous analysis through both paths is therefore not possible, since the cuvette must be rotated by 90° for changing the path. This change is not only time-consuming and interrupts the work flow, but also entails the risk of contamination or even spillage.

However, this is something that should be avoided in everyday laboratory life with regard to the health of the workforce on site and the usually cost-intensive and time-intensive production or procurement of the samples.

In the case of a simultaneous analysis by two crossing analysis paths, there is also the risk of obtaining falsified results, because, for example, the measuring processes influence one another in the crossing region.

The object of the present disclosure is therefore to provide a device for the measurement and/or the analysis of fluids, which eliminates the disadvantages known from the state of the art; in particular, to improve a cuvette for the measurement and/or analysis of a fluid in such a way that the measurement and/or analysis takes place more reliably, more quickly, more cost-effectively and more efficiently and the error rate is reduced at the same time.

This object is achieved according to the disclosure by a cuvette for analyzing a fluid, a method for analyzing fluids, a pipetting device and an automatic pipetting machine with the features of the independent claims.

The disclosures relates to particularly advantageous embodiments.

According to the disclosure, a cuvette for analyzing a fluid is proposed. Here, the cuvette comprises an interior space for receiving the fluid, wherein the interior space comprises an analysis section for analyzing the fluid, and the analysis section extends over two opposite sides of the cuvette. Here, the cuvette comprises a first opening for filling the cuvette, wherein the fluid can be introduced into the interior space via the opening. The analysis section of the cuvette has a first analysis path for analyzing the fluid and a second analysis path for analyzing the fluid. The first analysis path is shorter than the second analysis path in such a way that differently concentrated fluids can be analyzed by the first analysis path and the second analysis path, wherein the first analysis path and the second analysis path extend from a first side of the opposite sides of the cuvette to a second side of the opposite sides of the cuvette.

It is thus possible to build up a fluid column in the interior space along the analysis section, which fluid column varies in its thickness in accordance with the length of the analysis paths. The different thickness of the column makes it possible to examine fluids with different concentrations or different density. Thus, for example, an optically dense fluid could be analyzed by photometry along the short, first analysis path, while an optically less dense fluid can be analyzed along the long, second analysis path.

This can be carried out by an analysis apparatus. An analysis apparatus is preferably a device which can determine at least one parameter or measurement value via the fluid, wherein it has a sensor which can measure the corresponding parameter and its course over time. The analysis apparatus preferably also has an emitter which can emit all necessary signals, in particular radiation, which are necessary for the analysis of the sensor. This combination of emitter and sensor is designated in the context of this application as an analysis unit, which can in particular be part of the analysis apparatus.

In photometry, for example, the emitter emits light in at least one bandwidth, so that it penetrates through the fluid and can be detected on the other side of the fluid by the sensor. A statement about the optical density of the fluid can thus be made by the difference of emitted light and detected light. For the calculation of this data, a calculation module can be used which is both comprised by the analysis apparatus and can also be an external part. It goes without saying that other analysis methods than photometry which are known to the person skilled in the art can also be used for this purpose. For example, the analysis apparatus can emit radiation and detect the change which this radiation undergoes along the analysis path and thus permit conclusions to be drawn about the fluid in the analysis path. The radiation can in this case be, for example, polychromatic X-ray radiation for X-ray fluorescence analysis, radio radiation, visible light and/or UV-VIS radiation. It is likewise conceivable that, with a similar construction, other parameters of the fluid can be monitored along the analysis path, such as, for instance, temperature, fluorescence or the electrical conductivity, and can be used for analysis.

It is also conceivable that the cuvette has, in addition to the first analysis path and the second analysis path, further analysis paths which, in particular, have different lengths. Furthermore, it is conceivable that several parameters are collected simultaneously along a single analysis path or several analysis paths. This can in this case take place both by a single analysis apparatus which can detect all the parameters or else by a multiplicity of analysis apparatuses which collect only one parameter. The use of several analysis apparatuses for controlling the collected data is also conceivable.

The use of several analysis paths makes it possible, precisely in the case of unknown substances, to carry out an analysis which is as optimum as possible because, in this way, several data sets for the same fluid are present, but all differ at one point, namely the length of the analysis path on which they were collected.

This also has the advantage that several analyses can be carried out in one working step since, otherwise, a separate cuvette would have to be provided for each of these analyses and each analysis would have to be carried out in a separate step.

Thus, not only time is saved by the analyses being able to be carried out in one step, but material is also saved because fewer cuvettes are required for the same information gain. In addition, the quality of the collected data is improved because fewer transfer steps of fluids into the cuvette are necessary than are known from the state of the art. Since transfer steps can also always be sources of error in an analysis, it is thus ensured that the frequency of occurrence of this source of error is reduced.

In a preferred exemplary embodiment, the cuvette can have a second opening which is arranged on the sample space in such a way that the interior space forms a channel. As a result, it is possible to drain the fluid, which can be introduced into the cuvette via the first opening, out of the cuvette again via the second opening. The second opening can also be used to introduce the fluid into the cuvette again after the draining. The cuvette can be used as a pipette tip or as an attachment for a pipette tip.

In a preferred exemplary embodiment, the first analysis path and the second analysis path can be arranged next to one another on an axis between the first opening and the second opening in such a way that the first analysis path is arranged between the first opening and the second analysis path and the second analysis path is arranged between the first analysis path and the second opening. This is particularly advantageous because it simplifies the production of the pipette by an injection molding method, since the finished cuvette can thus be removed more easily from the casting mold.

Such a facilitated removal is synonymous with a reduced error rate during production and thus more cost-effective and resource-saving in the production process.

It is also conceivable that the first and the second analysis path are arranged next to one another in such a way that both are located on a plane orthogonal to the axis. This arrangement is to be designated in the context of this application as “arranged next to one another”. Such an arrangement has the advantage that the cuvette can be used variably in standard measuring apparatuses and/or analysis apparatuses, as are known to the person skilled in the art. Thus, cuvettes according to the disclosure can be used either in a measuring apparatus and/or analysis apparatus which has two analysis units for analyzing a fluid. In this way, different parameters can be collected simultaneously and/or the parameters collected by an analysis unit can be validated by a second and/or multiplicity of analysis units. This has the advantage that the measurement values obtained are more reliable.

In a preferred exemplary embodiment, the cuvette can have a connection region which is arranged on the first opening, such that a pipette tip can be attached to the cuvette. As a result, it becomes possible to fill the cuvette particularly precisely by a pipette. This has the advantage that the risk of errors when filling the cuvette is minimized. On the one hand, it is thus possible to prevent expensive fluids from being spilled when filling the cuvette and thus financial damage arising, on the other hand, the safety of the persons who are involved in the method is thus also increased.

The attachment of the pipette tip to the cuvette can in this case preferably take place in a sealing manner, for example in the form of a fluid connection. As a result, not only the escape of fluid at the transition between pipette tip and cuvette is prevented, but it is also possible for the fluid to be removed from the cuvette by the fluid-connected pipette tip via the first opening.

In addition, as a result of the fluid connection between the cuvette and the pipette tip, the fluid in the cuvette can also be dispensed via the second opening of the cuvette by applying a pressure to the distal (non-tip end of the pipette tip) end of the pipette tip, which pressure pushes the fluid column in the interior of the cuvette out of the second opening of the cuvette.

In addition, as a result of the fluid connection between the cuvette and the pipette tip, the fluid in the cuvette can also be received via the second opening of the cuvette by applying a suction to the distal (non-tip end of the pipette tip) end of the pipette tip, which suction sucks a fluid into the interior of the cuvette through the second opening.

In a preferred exemplary embodiment, one of the opposite sides of the cuvette can be thickened in the region of the analysis section on which the first analysis path extends between the two opposite sides of the cuvette. This region of the analysis section is the first section of the analysis section, which differs therein from the non-thickened, second section of the analysis section.

This has the advantage that, as a result of the thickening of one of the opposite sides in the first section of the analysis section on which the first analysis path also extends, the length of the first analysis path decreases linearly with respect to the increasing thickening of the side. As a result of the fact that the first analysis path becomes shorter, it can be used to analyze fluids which are too dense or highly concentrated in order to analyze them by a longer analysis path.

The thickening of the side of the cuvette can in this case take place in a stepped manner, so that several analysis paths with different lengths can extend in the analysis section.

It is also conceivable that both of the opposite sides of the cuvette can be thickened in the region of the analysis section, so that the length of the at least first analysis path can thus be changed.

It is also conceivable that the thickening of the opposite sides of the cuvette takes place in a stepped manner in the region of the analysis section, so that several analysis paths with different lengths can extend in the analysis section.

The use of several analysis paths makes it possible, precisely in the case of unknown substances, to carry out an analysis which is as optimum as possible because, in this way, several data sets for the same fluid are present, but all differ at one point, namely the length of the analysis path on which they were collected.

In a preferred exemplary embodiment of the cuvette, the first analysis path can be less than 0.9 mm long and the second analysis path can be between 0.95 mm and 2 mm long. Particularly preferably, the first analysis path can be less than 0.5 mm long and the second analysis path can be between 0.9 mm and 1.75 mm long, wherein the first analysis path can particularly preferably be less than 0.2 mm long and the second analysis path can particularly preferably be between 0.9 mm and 1.5 mm long.

In a preferred exemplary embodiment, the analysis section can have at least one measurement window at least on the first of the opposite sides, wherein at least one of the first or second analysis paths extends from the measurement window to the second side of the opposite sides of the cuvette, so that the fluid can be analyzed through the measurement window along the analysis path. This can also be understood to mean that a measurement value of the fluid can be collected through the measurement window, so that the fluid can be analyzed along the analysis path. Separate measurement windows can also be arranged on the different analysis paths. The measurement window (or also the entire cuvette) can consist of a transparent plastic, or other optically transparent materials known to the person skilled in the art which are suitable for installation in a cuvette.

In the context of the disclosure, optically transparent means that the measurement window (at least in a region of the measurement window) is transmissive for electromagnetic waves/radiation, in particular for electromagnetic waves/radiation in the UV/Vis range and/or NIR range or for the primary radiation.

In particular, an amorphous polymer can be used as transparent plastic. The cuvette and in particular the measurement window can comprise a cycloolefin copolymer. Cycloolefin copolymers are usually obtained by metallocene-catalyzed copolymerization of cycloolefins with alk-1-enes. In contrast to semicrystalline polymers such as polyethylene and polypropylene, cycloolefin copolymers are amorphous and thus optically transparent. Due to the low birefringence and optical transparency, the cycloolefin copolymers can be used particularly preferably for the optical analyses according to the disclosure (by the analysis apparatus).

This has the advantage that the influence of the cuvette body on the analysis of the fluid can be reduced, so that this problem known from the state of the art can be solved.

The cuvette and/or the measurement window can also be made of glass. Glass has the advantage over plastics that it is less susceptible to color changes which are caused, for example, by long storage times or incident radiation such as UV radiation. In addition, glass is less susceptible to scratches than most plastics. Both, the color fastness and the scratch resistance can reduce the influence that the cuvette has on the measurement process.

In addition, the measurement window can serve as a simple orientation aid when it is a matter of placing the cuvette correctly in the analysis apparatus in such a way that the analysis takes place along the analysis path and not, for example, orthogonally to the latter, as can occur in the case of incorrect insertion of the cuvette.

The incorrect insertion of the cuvette is a known source of error when working with cuvettes.

Especially in the case of novel cuvettes such as the one described in this application, the risk of incorrect insertion is great. Employees who use the new cuvettes can, as a result of being accustomed to earlier cuvettes, insert these new cuvettes in the same way as the old ones and do not notice their error. The measurement window can therefore be a simple and quickly checkable aid when inserting the cuvette into the analysis apparatus, which aid avoids this error.

In a preferred exemplary embodiment, the analysis section can be surrounded by a wall, and the wall has at least one measurement window for measuring the fluid in the interior space. The wall allows reliable setting down of the cuvette since the contact area with the base is thus increased, which on the one hand increases safety because potentially health-damaging fluids can thus escape less easily as a result of the cuvette being pushed around, on the other hand costs are also saved as a result if the risk of expensive or tediously produced fluids being spilled or a process for which they are necessary thus having to be started anew is reduced. Furthermore, the wall can be manufactured from a material which protects the interior space and thus the fluid located therein from external influences, such as for example radiation, and thus increases the quality of the analysis since, for example, interferences with the radiation which is used for the analysis are prevented. The material of the wall can of course be selected here in such a way that it protects from more than just one type of external influence. In addition to radiation, these influences can be, in particular, temperature, fluorescence or the electrical conductivity.

The measurement window allows here, analogously to the measurement window of the cuvette, an analysis of the cuvette content to be carried out and the influence of the wall surrounding the cuvette content on the analysis to be reduced.

In a preferred exemplary embodiment, the wall of the cuvette can be a pair of individual opposite partial walls, in particular two pairs of individual opposite partial walls. In this case, each of the individual partial walls can be manufactured from a material which protects the interior space from external influences, such as for example radiation. The use of different materials for the individual partial walls is also conceivable.

The one pair of opposite partial walls or both pairs of opposite partial walls allow reliable setting down of the cuvette since the contact area with the base is thus increased, which on the one hand increases safety because potentially health-damaging fluids can thus escape less easily as a result of the cuvette being pushed around, on the other hand costs are also saved as a result if the risk of expensive or tediously produced fluids being spilled or a process for which they are necessary thus having to be started anew is reduced.

In a preferred exemplary embodiment, the cuvette can have a conically tapering interior space. This has the advantage that the pipette tip can be introduced into the cuvette in a guided manner and holds it more securely there. Safety is increased as a result because the risk of an error occurring when introducing the pipette tip into the cuvette is reduced. At the same time, the risk of the cuvette slipping off the pipette tip at an early stage and thus potentially health-hazardous and expensive fluid escaping to the outside is also reduced. In addition, the working speed is increased since simple introduction and a secure fit make it possible to carry out the working steps more quickly.

It is conceivable here that the interior space preferably tapers conically along the analysis section.

It is also conceivable that the interior space of the cuvettes is manufactured in such a way that the pipette tip is held in the interior space by clamping force. This would be conceivable, for example, by a “press fit” in which a sealing fluid connection can be produced simultaneously between the cuvette and the pipette tip.

In a preferred exemplary embodiment of the cuvette, the interior space can be stepped, in particular stepped along the analysis section.

The stepped interior space has the advantage that safety is increased because the fit of the pipette tip in the cuvette is improved.

In addition, the stepped analysis section makes it possible to provide clearly defined analysis paths, wherein each step makes possible an analysis path with different lengths without having to thicken one of the opposite sides in the process. Material, production time and thus costs are thereby saved.

In addition, a method according to the disclosure for analyzing the contents of a cuvette according to the disclosure is proposed, which comprises the following steps: providing the cuvette, filling the cuvette with the fluid via the first opening, analyzing the fluid in the analysis section along the first and/or the second analysis path.

In this method, the analysis apparatus is used to obtain information about the fluid located in the cuvette both along the first analysis path and along the second analysis path. For this purpose, a signal is emitted by the emitter of the analysis apparatus, which signal passes through the fluid along the first and the second analysis path and is received by a sensor on the other side of the respective analysis path. Conclusions can thus be drawn about the properties of the fluid by the change in the signal.

The analysis along the first and the second analysis path serves different purposes. Dense and/or highly concentrated fluids can preferably be analyzed along the first analysis path. Less dense and/or highly concentrated fluids, on the other hand, can preferably be analyzed along the second, longer analysis path, so that it is ensured that measurement prerequisites which are as optimum as possible are met and thus measurement results which are as optimum as possible are achieved. The use of more than two analysis paths of different lengths is also conceivable in order to be able to use these advantages even more.

The analysis apparatus or apparatuses used in such a method can in this case comprise more than one emitter and sensor, or else analysis unit, wherein it is conceivable that each of these analysis units collects a different measurement parameter. However, it is also conceivable that each of the analysis units measures the same parameter in order to increase the reliability of the measurement. It is also conceivable that all collected measurement values of a parameter are averaged in order thus to obtain a reliable value for the examined parameter.

In a method according to the disclosure for analysis, the cuvette can be emptied again after the analysis. This has the advantage that no potentially hazardous or health-hazardous fluids remain in the cuvette.

In a method according to the disclosure, the cuvette can have a second opening and be emptied via the second opening after the analysis. This has the advantage that no potentially hazardous or health-hazardous fluids remain in the cuvette.

Here, it is also possible that further fluids are received into the cuvette via the second opening. Thus, for example, a washing solution during the ongoing analysis, so that further working steps in the cuvette are possible without running the risk that the contents of the cuvette become contaminated because a transfer would be necessary.

In addition, a cleaning solution can be received in this way after the analysis, so that the cuvette is cleaned, and can be used again after the dispensing of the cleaning solution from the cuvette, so that resources can be saved.

Furthermore, a pipetting device according to the disclosure for dosing a liquid by a fluid flow is proposed, wherein the pipetting device comprises a means for filling and emptying a cuvette attached to the pipetting device with the fluid flow, wherein the cuvette is connected in terms of flow to the means for filling and emptying. Here, the means for filling can be, for example, a pipette plunger. This can be operated manually or automatically. Of course, other means are also conceivable which are suitable for generating a fluid flow.

In an exemplary embodiment of a pipetting device according to the disclosure, the means for filling and emptying can be a device for generating or changing a pressure, in particular a pump with a pump chamber for generating a fluid flow. Such a pump has, among other things, the advantage that the volume of the fluid flow can be precisely determined, controlled and set.

In an exemplary embodiment of a pipetting device according to the disclosure, the device comprises a multiplicity of cuvettes. It is thereby possible to analyze the contents of several cuvettes in parallel. This results in advantages both for automation and for parallel working. In particular for parallel working with identical samples but also with different samples.

Furthermore, an automatic pipetting machine according to the disclosure is proposed, comprising a pipetting device according to the disclosure, and a movement device for moving the pipetting device in space/automatic pipetting machine. In addition, the automatic pipetting machine comprises an analysis apparatus for carrying out the analysis of the fluid in the cuvette. A pipetting device according to the disclosure can be moved in all spatial directions by the movement device. By the movement device, it is possible to move the pipetting device precisely, and thus to increase the quality of the work, since the pipetting device does not have to be held by hand. This reduces the occurrence of errors when filling cuvettes due to incorrect or poor positioning of the pipette tip with respect to the cuvette. In addition, in addition to this source of error, the risk potential for the persons on site is also reduced, since spillage of the samples by the user is avoided.

In an exemplary embodiment of the automatic pipetting machine according to the disclosure, the automatic pipetting machine can comprise a multiplicity of pipetting devices. This has the advantage that work can be carried out in parallel and thus the above-described advantages of increased working quality, speed and safety can also be used in the automatic pipetting machine.

In a further exemplary embodiment of the automatic pipetting machine according to the disclosure, the automatic pipetting machine has a control module for controlling the movement device. This control module allows remote-controlled and automated operation of the pipetting device. This results, above all, in the known advantages of automation. The error rate can thus be reduced, the constant quality of the work can be ensured and at the same time and thus costs for production and personnel can be saved.

In an exemplary embodiment of an automatic pipetting machine according to the disclosure, the automatic pipetting machine and/or the pipetting device has a sensor module which can provide the control module with information for automated control of the movement device. By this information, it is possible to check the position of the individual components of the automatic pipetting machine with respect to one another and, if necessary, to correct it, so that the error rate during filling and/or emptying can be reduced. In addition, the use of a sensor module and the associated checking and correction of the position of the parts of the automatic pipetting machine with respect to one another allows an autonomous mode of operation. As a result, personnel resources are freed since the time which is necessary for control and monitoring of the automatic pipetting machine can be reduced. In addition, safety is thus also increased since no persons come into contact with the substances during working.

The transmission of the information can take place via a cable connection or wirelessly. In the wireless transmission of information, the data/signal transmission takes place via free space (air or vacuum) as a transmission medium. The transmission can take place by directional or non-directional electromagnetic waves. Preferably, Bluetooth or WLAN is used.

In an automatic pipetting machine according to the disclosure, the device comprises a storage container for cuvettes. This allows faster processing because new cuvettes can be provided directly and can thus be received quickly. Furthermore, the provision of a storage container with cuvettes minimizes the probability of contamination since less frequently has to be interacted with the automatic pipetting machine from the outside.

Likewise, the device can comprise a storage container for pipette tips, which offers the same advantages as the storage container for cuvettes.

In order to reduce the risk of contamination even further, the automatic pipetting machine or at least the pipetting device can be arranged in a housing. In particular, the housing encloses the automatic pipetting machine or the pipetting device in all directions, with the result that the housing forms a treatment space in which work can be carried out under a hermetically sealed atmosphere. However, advantageous effects are also already achieved by a housing without hermetic sealing. In addition, a simple separation wall for reducing draft air or a cover, which can be arranged around the automatic pipetting machine or the pipetting device, is also conceivable.

One advantage of the cuvette according to the disclosure is in particular that known laboratory machines and pipetting devices can be easily upgraded to an automatic pipetting machine according to the disclosure or a pipetting device according to the disclosure since the cuvettes already present can be replaced by the cuvettes according to the disclosure.

The retrofitting of an analysis apparatus into known laboratory machines and pipetting devices is also conceivable and possible.

It goes without saying that the exemplary embodiments mentioned here have no limiting character and the different features of the exemplary embodiments and the exemplary embodiments themselves can be combined with one another.

### BRIEF DESCRIPTION OF THE DRAWINGS

The disclosure is explained in more detail below on the basis of exemplary embodiments with reference to the drawings. The drawings show:

FIG. 1 is a schematic representation of a cuvette known from the state of the art;

FIG. 2 is a schematic representation of a cuvette according to the disclosure for analyzing a fluid;

FIG. 3 is a schematic representation of a cuvette according to the disclosure with partial walls;

FIG. 4 is a schematic representation of a pipetting device according to the disclosure;

FIG. 5 is a schematic representation of an automatic pipetting machine according to the disclosure arranged in a housing.

### DETAILED DESCRIPTION

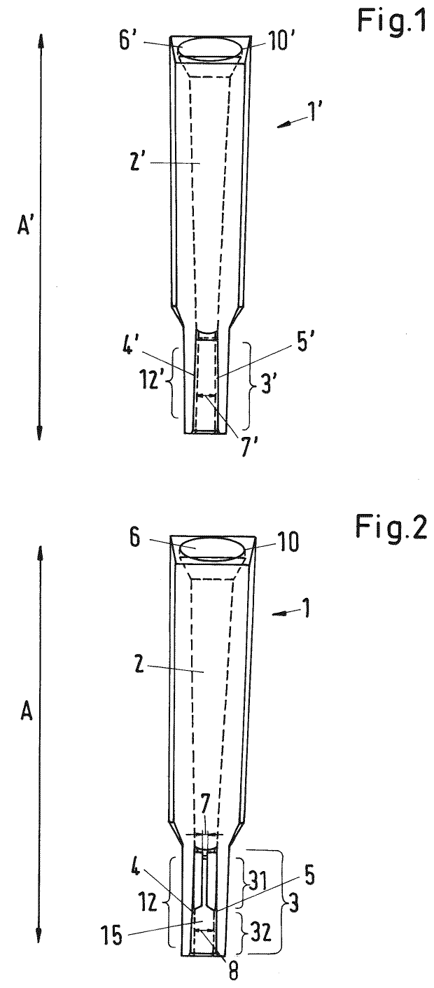

To explain a known adapter for a pipette, reference is made below to FIG. 1, on the basis of which the state of the art is described in more detail. To distinguish the state of the art from the present disclosure, the reference numbers, which relate to features of known examples, are provided with an inverted comma, while features of exemplary embodiments according to the disclosure are provided with reference numbers which do not bear an inverted comma.

FIG. 1 shows a cuvette 1′ known from the state of the art, comprising a first opening 6′ for filling an interior space 2′ and a connection region 10′ for connecting a pipette tip. Furthermore, the cuvette 1′ comprises an analysis section 3′ which extends over a first opposite side 4′ and a second opposite side 5′ and comprises a measurement window 12′ for analyzing a fluid along a first/single analysis path 7′.

FIG. 2 shows a schematic representation of a cuvette 1 according to the disclosure for analyzing a fluid, comprising an interior space 2 for receiving the fluid, wherein the interior space 2 comprises an analysis section 3 for analyzing the fluid, and the analysis section 3 extends over two opposite sides 4 and 5 of the cuvette 1, and wherein the cuvette 1 has a first opening 6 for filling the cuvette 1, wherein the fluid can be introduced into the interior space via the first opening, and the analysis section 3 has a first analysis path 7 for analyzing the fluid and a second analysis path 8 for analyzing the fluid. The first analysis path 7 is arranged in a first section 31 of the analysis section 3 and is shorter than the second analysis path 8 in such a way that differently concentrated fluids can be analyzed by the first analysis path 7 and the second analysis path 8, which is arranged in a second section 32 of the analysis section 3. The first analysis path 7 and the second analysis path 8 extend from a first side 4 of the opposite sides 4 and 5 of the cuvette 1 to a second side 5 of the opposite sides 4 and 5 of the cuvette.

The interior space 2 forms a channel through a second opening 9 (not represented here) which is arranged on the sample space 15 of the cuvette 1.

The first analysis path 7 and the second analysis path 8 are arranged next to one another on an axis A between the first opening 6 and the second opening 9 (not represented here) in such a way that the first analysis path 7 is located between the first opening 6 and the second analysis path 8 and the second analysis path 8 is located between the first analysis path 6 and the second opening 9 (not represented here).

The cuvette 1 has a connection region 10 on the first opening 6, such that a pipette tip (not shown) can be attached to the cuvette 1.

The cuvette 1 shown in FIG. 2 is thickened on the opposite sides 4 and 5 of the cuvette 1 in the first section 31 of the analysis section 3 on which the first analysis path 7 extends between the two opposite sides 4 and 5 of the cuvette 1.

The first analysis path 7 is less than 0.9 mm long and the second analysis path 8 is between 0.95 mm and 2 mm long. In particular, the first analysis path 7 is less than 0.5 mm long and the second analysis path 8 is between 0.9 mm and 1.75 mm long, wherein the first analysis path 7 is particularly preferably less than 0.2 mm long and the second analysis path 8 is particularly preferably between 0.9 mm and 1.5 mm long.

The cuvette 1 shown in FIG. 2 comprises an analysis section which has a measurement window 12 on the first opposite side 4 of the opposite sides 4 and 5. The first analysis path 7 and the second analysis path 8 extend from the measurement window 12 to the second side 5 of the opposite sides 4 and 5 of the cuvette 1, such that the fluid can be analyzed through the measurement window 12 along the first analysis path 7 and the second analysis path 8. Or a measurement value of the fluid can be collected through the measurement window, such that the fluid can be analyzed along the analysis path.

The cuvette 1 also shows a conically tapering interior space 2 which preferably tapers conically along the analysis section 3.

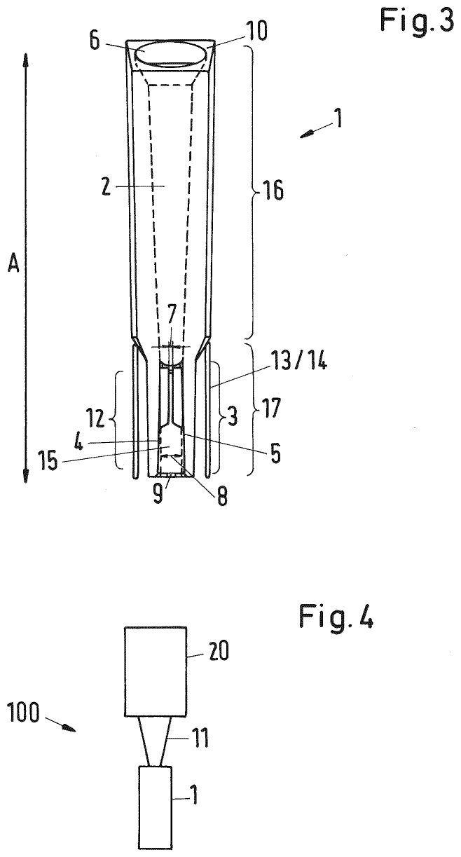

FIG. 3 shows a schematic representation of a cuvette 1 according to the disclosure, wherein the cuvette 1 has a first cuvette section 16 and a second cuvette section 17. At the transition from the first cuvette section 16 to the second cuvette section 17, at least one partial wall 14 is arranged which extends along the second cuvette section and has at least one measurement window 12 for measuring the fluid in the interior space.

The partial wall 14 of the cuvette 1 shown in FIG. 3 can be a pair of individual opposite partial walls, in particular two pairs of individual opposite partial walls. The two pairs of individual opposite partial walls 14 can be arranged on one another in such a way that they form a wall 13 which surrounds the second cuvette section.

The cuvette 1 from FIG. 3 also shows a stepped interior space 2. In particular along the analysis section 3, the interior space is stepped, so that a first analysis path 7 and a second analysis path 8 result.

The cuvette 1 according to the disclosure shown has a first opening 6 via which the cuvette 1 can be filled. For example, it can be filled with a fluid. In the analysis section 3 of the cuvette 1, this fluid can be analyzed along the first analysis path 7 and/or the second analysis path 8.

FIG. 3 also shows that the cuvette has a second opening 9 via which the fluid can be dispensed from the cuvette 1 after the analysis.

FIG. 4 shows a schematic representation of a pipetting device 100 according to the disclosure for dosing a liquid by a fluid flow, wherein the pipetting device 100 comprises a cuvette 1 according to the disclosure. In this case, the cuvette 1 is connected in terms of flow to a means 20 for filling and emptying the cuvette 1. The means 20 fills and empties the cuvette 1 via a fluid flow. A pipette tip 11 is arranged between the means 20 and the cuvette 1, which pipette tip is introduced into the cuvette 1 and establishes the flow connection between the cuvette 1 and the means 20.

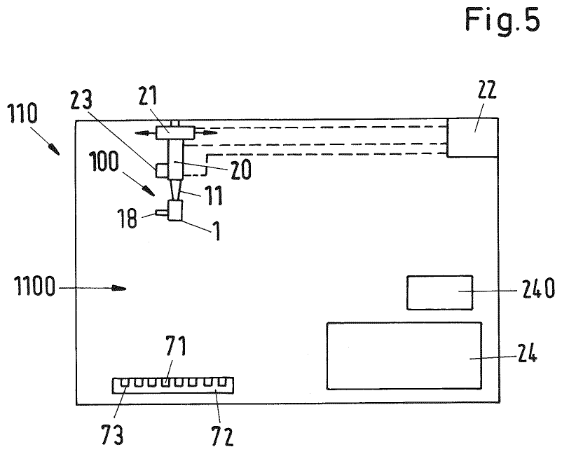

FIG. 5 shows a schematic representation of an automatic pipetting machine 110 according to the disclosure, arranged in a housing.

The automatic pipetting machine 110 comprises a treatment space 1100 for receiving a sample and a pipetting device 100 according to the disclosure which is arranged for carrying out at least one processing step on a sample 71 in the treatment space 1100. In addition, the automatic pipetting machine 110 comprises a sample module 72 in which sample containers 73 are arranged.

The automatic pipetting machine 110 in this case comprises a pipetting device 100, and a movement device 21 for moving the pipetting device 100. The movement device 21 allows the movement of the pipetting device 100 in all directions in space.

A cuvette 1 according to the disclosure can also be fastened to the pipetting device 100 by a pipette tip 11 and, in addition, can be removed again from the pipette tip 11 and thus from the pipetting device 100 after the fastening. The cuvette 1 in this case can also be removed from the automatic pipetting machine 110 after the removal from the pipetting device 100.

The pipetting device 100 for dosing a liquid by a fluid flow can in this case comprise a means 20 for filling and emptying a cuvette 1 attached to the pipette tip 11 with the fluid flow, wherein the pipette tip 11 is connected in terms of flow to the means 20 for filling and emptying.

The means 20 for filling and emptying a device for generating or changing a pressure can in this case be, in particular, a pump with a pump chamber for generating a fluid flow.

The pipetting device 100 comprises a cuvette 1 but can also comprise a multiplicity of cuvettes 1.

The automatic pipetting machine 110 comprises a pipetting device 100 but can also comprise a multiplicity of pipetting devices 100.

The automatic pipetting machine 110 in this case has a control module 22 for controlling the movement device 21.

It is possible in this case for the automatic pipetting machine 110 and/or the pipetting device 100 to have a sensor module 23 which provides the control module 22 with information for automated control of the movement device 21.

The automatic pipetting machine 110 in this case has storage containers 24 for cuvettes 1 and/or pipette tips 11 and a disposal container 240 for cuvettes 1 and/or pipette tips 11.

The automatic pipetting machine furthermore comprises an analysis apparatus 18 for carrying out the analysis of the fluid in the cuvette 1.

As a result of the features explained above, the present disclosure therefore allows for the first time fluids of different densities and concentrations to be analyzed in the same cuvette without in this case generating a difference in quality between the analysis results of the different fluids and without having to change the arrangement of the cuvette between the analysis processes.

As a result, a higher precision of the measurement data is achieved and at the same time a more efficient mode of operation is achieved, since the cuvette does not have to be moved in order to change the analysis path. In addition to the speed saving, safety is thus also increased because spillage of the cuvette content is less likely as a result of the movement step being omitted. A reduction in the risk of spillage is also synonymous with a cost saving since the valuable fluids are lost less frequently as a result.

What is claimed:

1. A cuvette for analyzing a fluid, comprising:
an interior space to receive the fluid, the interior space comprising an analysis section configured to analyze the fluid, and the analysis section extending over two opposite sides of the cuvette; and
a first opening to fill the cuvette, the fluid capable of being introduced into the interior space via the first opening, and the analysis section having a first analysis path to analyze the fluid and a second analysis path to analyze the fluid, the first analysis path being shorter than the second analysis path such that differently concentrated fluids are capable of being analyzed by the first analysis path and the second analysis path,
the first analysis path and the second analysis path extend from a first side of the opposite sides of the cuvette to a second side of the opposite sides of the cuvette.

2. The cuvette according to claim 1, wherein a second opening is arranged on the sample space such that the interior space forms a channel.

3. The cuvette according to claim 2, wherein the first analysis path and the second analysis path are arranged next to one another on an axis between the first opening and the second opening such that the first analysis path is located between the first opening and the second analysis path and the second analysis path is located between the first analysis path and the second opening.

4. The cuvette according to claim 1, wherein a connection region is arranged on the first opening, such that a pipette tipis capable of being attached to the cuvette.

5. The cuvette according to claim 1, wherein one of the opposite sides of the cuvette is thickened in a region of the analysis section on which the first analysis path extends between the two opposite sides of the cuvette.

6. The cuvette according to claim 1, wherein the first analysis path is less than 0.9 mm long and the second analysis path is between 0.95 mm and 2 mm long.

7. The cuvette according to claim 1, wherein the analysis section has at least one measurement window at least on the first of the opposite sides, and at least one of the first or second analysis paths extends from the measurement window to the second side of the opposite sides of the cuvette, such that the fluid is capable of being analyzed through the measurement window along the at least one of the first or second analysis paths.

8. The cuvette according to claim 1, wherein the analysis section is surrounded by a wall, and the wall has at least one measurement window for measuring the fluid in the interior space.

9. The cuvette according to claim 8, wherein the wall comprises a pair of individual opposite partial walls.

10. The cuvette according to claim 1, wherein the interior space tapers conically.

11. The cuvette according to claim 1, wherein the interior space is stepped.

12. The cuvette according to claim 1, wherein the first analysis path is less than 0.2 mm long and the second analysis path is between 0.9 mm and 1.5 mm long.

13. The cuvette according to claim 1, wherein the interior space tapers conically along the analysis section.

14. The cuvette according to claim 1, wherein the interior space is stepped along the analysis section.

15. A method for analyzing, comprising:
providing the cuvette according to claim 1;
filling the cuvette with the fluid via the first opening; and
analyzing the fluid in the analysis section along the first analysis path or the second analysis path.

16. The method according to claim 15, wherein the cuvette has a second opening and is emptied via the second opening after the analysis.

17. A pipetting device for dosing a liquid by a fluid flow, comprising:
the cuvette according to any claim 1,
a a device configured to fill the cuvette attached to the pipetting device with the fluid flow, the cuvette configured to be connected to the device for filling and emptying.

18. An automatic pipetting machine comprising:
the pipetting device according to claim 17; and
a movement device to move the pipetting device and an analysis apparatus to carry out analysis of the fluid in the cuvette.
